(19) United States
(12) Patent Application Publication
(10) Pub. No.: US 2008/0063558 A1
(43) Pub. Date: Mar. 13, 2008

(54) Odour Reduction Apparatus

(76) Inventor: Malcolm Coleman, South Australia (AU)

Correspondence Address: GREENBLUM & BERNSTEIN, P.L.C., 1950 ROLAND CLARKE PLACE, RESTON, VA, 20191, US

(21) Appl. No.: 11/575,007

(22) PCT Filed: Sep. 9, 2005
(86) PCT No.: PCT/AU05/01361

§ 371 Date: Jun. 29, 2007

(30) Foreign Application Priority Data
Sep. 10, 2004 (AU) 2004-905161

(51) Int. Cl. A61L 9/16; B01D 45/10; B01D 47/06; B01D 47/12; B03C 3/01; B03C 3/014; B03C 3/017; B03C 3/34

(52) U.S. Cl. 422/4; 95/62; 95/71; 95/74; 95/78; 96/27; 96/43; 96/52; 96/53

(57) ABSTRACT

The invention is an air filter for reducing the amount of particles in air. In the preferred form, the particles are odour particles. The air filter comprises two spaces disposed between an air inlet and an air outlet. Odorous air is drawn into the air filter and pre-treated in a first space, having air flow baffles and jets which both agitate and charge the air by a process of triboelectrification. In the second space the airstream impinges upon a number of spaced-apart baffles or structured layers. The odour particles in the air are attracted to the surfaces of the baffles and are removed by the action of the water flow. The air filter of the present invention can treat air from installations such as agricultural operations, air from apartment buildings, air from restaurants, factories and other industrial facilities, vehicle exhaust system and effluent ponds and is also applicable to removing other particles types such as pollen.

### FIELD OF THE INVENTION

The present invention relates to a method and apparatus for the reduction of particles in air.

### BACKGROUND OF THE INVENTION

Impurities in air can cause significant adverse effects on people's lives and well-being. Impurities such as pollen particles or similar respiratory sensitisers can trigger asthma attacks in individuals who inhale the impure air. Another type of impurity in air is odour which can be offensive or irritating if inhaled by a person. Problems can occur when inadequate ventilation systems are installed, or are not properly maintained, in spaces such as industrial facilities, effluent plants, restaurants, hot food take-aways or agricultural operations, e.g. poultry sheds.

Once inhaled by a person, an odour stimulates the olfactory glands resulting in what is known as smell. With some odours, only a few particles may be needed to cause a smell.

Most odours comprise a combination of particles including fine particulate matter (particles greater than 1 μm in diameter) as well as vapour (particles less than 1 μm in diameter). The term odour particle in this document is intended to cover both particulate matter and vapour. Occasionally, odours which cause a problem may not be considered malodorous, but rather are persistent odours. For example, the smell of take-away food may cause a problem to residents adjacent to the take-away's location.

Odour can cause a problem once it is emitted from a space into the surrounding atmosphere, and can also cause a problem inside an enclosed space if the odour is not quickly and efficiently emitted. For example, toilet or garbage smells circulating within the interior of a restaurant or an apartment building can be offensive to the inhabitants. In some jurisdictions, there is legislation that places a duty on the owner or operator of a restaurant to take all reasonable steps to prevent any objectionable odour from being emitted from the restaurant which may be noticeable to any nearby residents.

Another area in which odour can cause a significant problem is intensive farming. The presence of a large number of animals within the confines of a shed, for example a poultry shed, leads to a rapid build-up of heat, organic matter and odour within the shed. In residential areas, the odour is a significant problem. In general, people living in urban or semi-urban residential areas will not tolerate the constant odour from, for example, poultry sheds. This problem of odour can be so severe that, in many areas, otherwise efficient poultry sheds, presenting no health risk to the community, are being dismantled and removed, either at the direction of environmental authorities or because the owners no longer feel able to resist pressure from their residential neighbours.

Attempts to deal with this problem with simple emission control solutions have been generally ineffective. The adoption of more sophisticated techniques of emission control have also often proved ineffective. Even if such techniques have proved effective, they have often been prohibitively expensive or prohibitively difficult to manage in an agricultural environment.

It is an object of the present invention to provide an improved air filter for reducing particles in air which eliminates or at least reduces some of the problems associated with the prior art discussed above.

### SUMMARY OF THE INVENTION

In one form, although this may not be the only or broadest form, there is provided an air filter comprising
an air inlet to allow air containing particles to enter the air filter;
an air outlet to allow the air from which at least some particles have been removed to exit the air filter;
one or more baffles disposed between the air inlet and the air outlet to allow the air containing particles to contact at least a portion of the one or more baffles; and
one or more fluid releasing means for releasing fluid over the at least a portion of the one or more baffles, thereby reducing the amount of particles in the air containing particles.

Preferably, the particles in the air are odour particles.

Preferably, at least some of the particles in the air which contacts the at least a portion of the one or more baffles are charged.

More preferably, the charged particles are attracted to the one or more baffles.

Preferably, at least a portion of the baffles is made from a material capable of supporting an electrostatic charge.

More preferably, the material capable of supporting an electrostatic charge is a plastic.

Preferably, the electrostatic charge is induced on the at least a portion of the one or more baffles by the fluid flowing over the at least a portion of the one or more baffles.

Preferably, the fluid releasing means are jets.

Preferably, the fluid that is released by the fluid releasing means is water.

Alternatively, the fluid released by the fluid releasing means is an aqueous solution.

Preferably, the one or more baffles have substantially vertical surfaces so that the fluid released from the fluid releasing means flows down the substantially vertical surfaces of the one or more baffles, the flow of the fluid thereby removing at least some of the odour particles attracted to the one or more baffles.

More preferably, fluid released drips from the bottom of the one or more baffles.

Preferably, the air filter further comprises a drain for removing fluid released by the fluid releasing means.

More preferably, the drain is passed through a particulate and/or chemical filter and is then returned to the fluid releasing means for re-use.

Preferably the air filter further comprises at least two baffles which are spaced apart from one another.

More preferably, the spacing between the at least two baffles is adjustable.

In another form, there is provided an air filter comprising:
a first space and a second space, disposed in air flow communication between an air inlet for receiving air containing particles and an air outlet for exhausting air from which at least some of the particles have been removed;
the first space including one or more first space fluid releasing means disposed to release first space fluid into the air containing particles flowing through the first space;
the second space including one or more second space baffles disposed to allow the air containing particles flowing through the second space from the first space to contact at least a portion of the one or more second space baffles, and further including one or more second space fluid releasing means disposed so as to release second space fluid over the at least a portion of the one or more second space baffles.

Preferably, the particles are odour particles.

Preferably, the first space further comprises one or more first space baffles, disposed so as to disrupt air flow through the first space.

Preferably, a charge is imparted to the particles in the air flowing through the first space.

More preferably, at least some of the charged particles are attracted to the one or more second space baffles.

Preferably, at least a portion of the first space is made from a material capable of inducing a charge on the odour particles.

Preferably, the material capable of inducing a charge on the particles has a low work function.

More preferably, the material capable of inducing a charge on the odour particles is steel.

Preferably, at least a portion of the second space is made from a material capable of supporting an electrostatic charge.

More preferably, the material capable of supporting an electrostatic charge is a plastic.

Preferably, an electrostatic charge is induced on the one or more second space baffles by the second space fluid flowing over the surface of the one or more second space baffles.

Preferably, the first space fluid releasing means and the second space fluid releasing means are jets.

Preferably, the first space fluid or the second space fluid that is released by the first space fluid releasing means or the second space fluid releasing means respectively, is water.

Alternatively, the first space fluid and/or the second space fluid that is released by the first space fluid releasing means and/or the second space fluid releasing means respectively is an aqueous solution.

Alternatively, the first space fluid that is released by the first space fluid releasing means is air.

Preferably, the one or more second space baffles have substantially vertical surfaces so that the second space fluid released from the second space fluid releasing means flows down the substantially vertical surfaces of the one or more second space baffles, the flow of the second space fluid thereby removing at least some of the odour particles attracted to the one or more second space baffles.

More preferably, the second space fluid released in the second space drips from the bottom of the one or more second space baffles.

Preferably, the first space further comprises a drain for removing first space fluid released by the first space fluid releasing means.

Preferably, the second space further comprises a further drain for removing second space fluid released by the second space fluid releasing means.

More preferably, the first space fluid and/or the second space fluid from the drain and/or the further drain respectively is passed through a particulate and/or chemical filter and is then returned to the first space fluid releasing means and/or second space fluid releasing means for re-use.

Preferably, the second space comprises at least two second space baffles spaced apart from one another.

More preferably, the spacing between the at least two second space baffles is adjustable.

In another form, although this may not be the only or broadest form, there is provided a method for reducing particles, the method comprising:
in a first space, mixing air containing particles with a first space fluid to produce mixed air;
causing the mixed air to flow into a second space;
in the second space, removing the particles from the mixed air to produce air with a reduced amount of particles; and
expelling the air with the reduced amount of particles from the second space.

Preferably, the particles in the air are odour particles.

Preferably, the first space fluid is water.

Alternatively, the first space fluid is an aqueous solution.

Alternatively, the first space fluid is air.

Preferably, the method further comprises, in the first space causing the mixed air to pass over one or more first space baffles.

More preferably, the step of mixing in the first space facilitates inducing a charge on the particles.

Preferably, the step of inducing a charge on the particles includes causing the mixed air to flow over at least a portion of the first space which is capable of inducing a charge on the particles.

More preferably, the portion of the first space capable of inducing a charge on the particles has a low work function.

Preferably, the portion of the first space capable of inducing a charge on the particles is steel.

Preferably, the method further comprises, in the second space removing the charged particles.

More preferably, the step of removing the charged particles includes causing the mixed air to flow over at least a portion of the second space which is capable of removing the charged particles.

Preferably, the portion of the second space capable of removing the charged particles is made from a material capable of supporting an electrostatic charge.

More preferably, the material capable of supporting an electrostatic charge is a plastic.

Preferably, the method further comprises, in the second space causing the mixed air to flow over one or more second space baffles.

More preferably, the method further comprises in the second space providing a second space fluid releasing means for releasing second space fluid into the second space.

Preferably, the second space fluid that is released by the second space fluid releasing means is water.

Alternative, the second space fluid released by the second space fluid releasing means is an aqueous solution.

Preferably, the one or more second space baffles have substantially vertical surfaces so that the second space fluid flows down the substantially vertical surfaces of the one or more second space baffles, the flow of the second space fluid thereby removing at least some of the particles attracted to the surfaces of the one or more second space baffles.

More preferably, an electrostatic charge on the one or more second space baffles is induced by the second space fluid flowing over the surface of the one or more second space baffles.

In another form, although this may not be the only or broadest form, there is provided a method for reducing particles, the method comprising:
causing air containing particles to flow into a space via an air inlet;
causing the air containing particles to contact at least a portion of one of more baffles disposed within the space;
releasing fluid over at least a portion of the one or more baffles; and
expelling air with a reduced amount of particles from the space.

Preferably, the particles in the air are odour particles.

Preferably, the fluid released over a portion of the one or more baffles is water.

Alternatively, the fluid released over a portion of the one or more baffles is an aqueous solution.

Preferably, at least some of the particles in the air are charged.

Preferably, the one or more baffles are made from a material capable of supporting an electrostatic charge.

More preferably, the material capable of supporting an electrostatic charge is a plastic.

Preferably, the one or more baffles have substantially vertical surfaces so that the fluid flows down the substantially vertical surfaces of the one or more baffles, the flow of the fluid thereby removing at least some of the particles attracted to the surfaces of the one or more baffles.

Preferably, an electrostatic charge on the one or more second space baffles is induced by the fluid flowing over the surface of the one or more baffles.

In another form, although this may not be the only or broadest form, there is provided an air filter further comprising a space disposed between the air inlet and the one or more baffles.

Preferably, a charge is imparted to the particles in the air flowing through the space.

More preferably, at least a portion of the space is made from a material capable of inducing a charge on the particles flowing through the space.

Preferably, the material capable of inducing a charge on the particles has a low work function.

More preferably, the material capable of inducing a charge on the odour particles is steel.

Preferably, the space further comprises at least one fluid releasing means for releasing fluid into the air flowing through the space.

Preferably, the fluid that is released by the fluid releasing means is water.

More preferably, the fluid releasing means is an aqueous solution.

Preferably, the space further comprises one or more first space baffles, disposed so as to disrupt air flow through the space.

The invention will be generally discussed in relation to odour minimisation from poultry sheds, but it is not so restricted and may be applied to other enclosures where a decrease in particles in the air is required or desired. For example, pollen particles could be removed from air prior to circulating the air within a building. Furthermore, air from any space could be treated before being released into the surrounding atmosphere, for example, air from other agricultural operations such as mushroom growing facilities; air from apartment buildings; air from take-aways, restaurants and other food businesses; air from factories and other industrial facilities etc. It is also an option that air from a vehicle exhaust system be treated by the air filter of the present invention before the air is exhausted from the vehicle into the surrounding atmosphere. Furthermore, the air filter may be used to treat odorous air from effluent ponds by arranging a series of air filters around the ponds or by covering the ponds with a sheet to capture air which is then fed into the air filter of the present invention.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgement or any form of suggestion that such prior art forms part of the common general knowledge.

Specific embodiments of the invention will now be described in some further detail with reference to and as illustrated in the accompanying figures. These embodiments are illustrative, and not meant to be restrictive of the scope of the invention. Suggestions and descriptions of other embodiments may be included within the scope of the invention but they may not be illustrated in the accompanying figures or alternatively features of the invention may be shown in the figures but not described in the specification.

### BRIEF DESCRIPTION OF THE DRAWINGS

An illustrative embodiment of the present invention will be discussed with reference to the accompanying drawings and examples wherein:

FIG. 1 is a cross-sectional side-view of the air filter according to a preferred embodiment of the present invention;

FIG. 2 is a perspective top-view of the air filter of FIG. 1;

FIG. 3 is a cross-sectional top-view of the air filter of FIGS. 1 and 2 according to a preferred embodiment of the present invention;

FIG. 4 is a close-up view of the plastic baffles used in the second space of the present invention; and

FIG. 5 is a Table showing the percentage reduction in odour emitted from the air filter of the present invention.

### DESCRIPTION OF PREFERRED EMBODIMENT

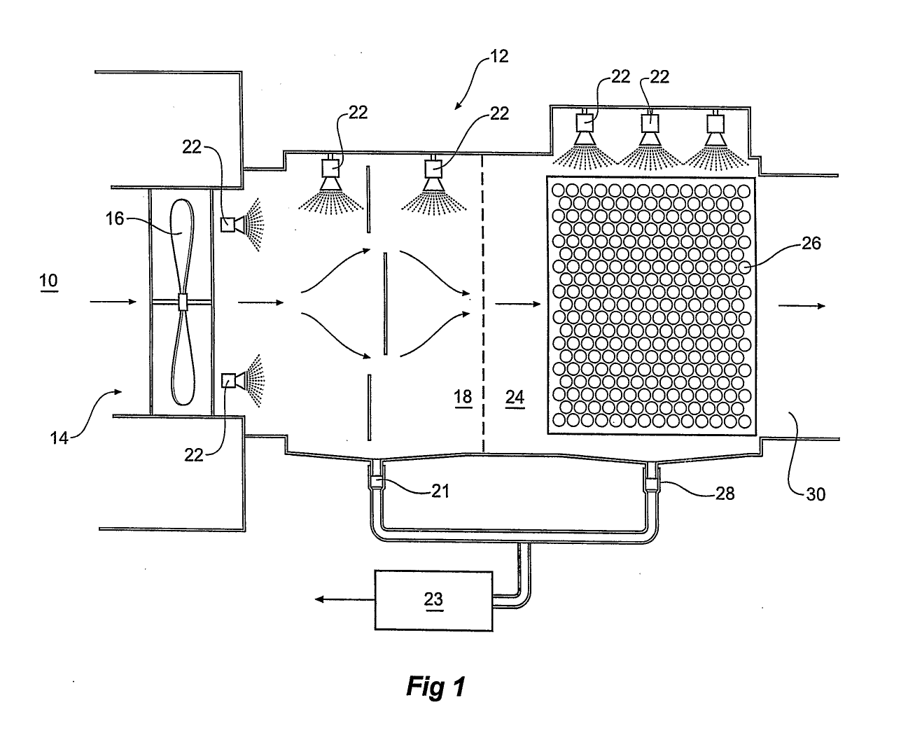

Referring to FIG. 1 there is a cross-sectional side-view of the present air filter 12. The air filter 12 is connected to enclosed space 10 from which particles, in this case odour particles, are desirably removed or at least reduced. In this case, the enclosed space is poultry shed 10. Poultry shed 10 is connected to air filter 12 via air inlet 14.

Air containing particles (in this case odour particles) is drawn from the poultry shed 10 by fan 16. The direction of air flow is shown in FIG. 1 by arrows. Any means of drawing air from poultry shed 10 could be used, for example, air could be blown or sucked into the air filter. Once inside air filter 12, the airstream (which should be understood to contain particles) enters a first space 18 which contains within it a number of first space airflow baffles 20. For clarity, the boundary between first space 18 and the second space 24 (discussed below) is indicated by a dotted line. First space baffles 20 are positioned so that they break or disrupt the flow of air, thereby causing a degree of turbulence within first space 18.

First space 18 has within it a number of first space fluid releasing means or jets 22 which release or spray first space fluid into space 18. These jets 22 are positioned above first space baffles 20 and to the side of first space baffles 20. The jets 22 to the side of first space baffles 20 spray first space fluid in substantially the same direction as the air coming in via air inlet 14. Any number of jets may be used within space 18, however in the preferred embodiment three jets are positioned above first space baffles 20 and six jets are positioned to the side of first space baffles 20.

In the preferred embodiment the first space fluid released is water, however, any fluid which acts to agitate the air flowing into the first space could be used. For example, a liquid such as water or other substantially aqueous fluids could be used. Alternatively air could be released by the jets into the first space.

First space baffles 20 ensure that substantial mixing between the water droplets released into the first space and the airstream from inlet 14 occurs. It is an option that the first space does not contain baffles, however, it will be understood that first space baffles 20 substantially increase the efficiency of mixing air from air inlet 14 with water released from jets 22.

A substantial amount of particulate matter, such as dust, dirt, feathers etc, will be washed out of the first space by the water droplets. The water flows away to a drain 21 and can then be filtered by filter 23, prior to collection. The filter can be backwashed and emptied as required. It is an option that the collected water be recycled if desired. The recycled water can then be reused in the air filter 12, thereby providing a continuous water supply.

It is an option that no first space fluid is released into the first space. However, the absence of a fluid to provide some turbulence or agitation within the space will reduce the efficiency of odour removal.

All of the components within first space 18, including the lining of the first space, as well as jets 22, pipes which supply jets 22 and first space baffles 20, including the supports of first space baffles 20, are formed from a metal. It is an option that some of the components in the first space are not made of metal, however, the efficiency of odour removal will then decrease. In the preferred embodiment, first space baffles 20 are flat stainless steel panels. Other materials which could be used in place of stainless steel and which are deemed to be within the scope of the invention are discussed below.

The mixed air, which has been pre-treated in first space 18 and has water entrained within it in droplet form, flows into second space 24. Again, the boundary of the second space 24 is identified by the dotted line in FIG. 1. The airstream impinges upon a number of spaced-apart second space baffles (or structured layers) 26, vertically mounted within second space 24. For clarity, second space baffles 26 are shown as a series of circles in FIG. 1. However, the second space baffles have protrusions and indentations on the surface to increase surface area. Second space baffles 26 have a large overall surface area and are arranged such that the gaps between each second space baffle form channels, running in the approximate direction of the impinging airstream.

Second space 24 also includes within it a number of second space fluid releasing means which are jets 22 for spraying a second space fluid such as water into the second space. Again, any number of jets may be used in space 24, however, in the preferred embodiment ten jets are arranged above the second space baffles 26 and provide a water flow which runs down the vertically disposed surfaces of second space baffles 26 into the channels formed between the second space baffles through which air will flow. In the preferred embodiment the second space fluid released is water, however, substantially aqueous fluids could be used.

In the preferred embodiment the outer casing of the air filter 12 is made from a conductive material such as steel, therefore second space baffles 26 are insulated from the conductive outer casing by disposing the second space baffles within a wooden container (not shown). It is an option that the outer casing of the air filter be made from a non-conductive material such as concrete. If a non-conductive material is used for the outer casing of the air filter then second space baffles 26 need not be encased within a wooden container.

The water which runs down the surfaces of second space baffles 26, under the force of gravity, washes out any remaining particulate matter and some odour from the airstream which was not removed in first space 18. The action of the water also cleans the surface of second space baffles 26. Again, this waste water flows down a drain 28 and may be filtered by filter 23, collected and/or recycled, if desired.

All of the components within second space 24, including the lining of the second space, as well as jets 22, pipes which supply jets 22 and second space baffles 26, including the supports of second space baffles 26, are formed from a material capable of supporting an electrostatic charge (as described below). It is an option that some of the components in the second space are not made from a material capable of supporting an electrostatic charge, however, the efficiency of odour removal will then decrease. In the preferred embodiment, second space baffles 26 are formed from a plastic material such as polyethylene (PE), Polyethylene Terephthalate (PET), High Density Polyethylene (HDPE) or Polypropylene (PP). Other materials which could be used in place of plastic, and which are deemed to be within the scope of the invention, are discussed below.

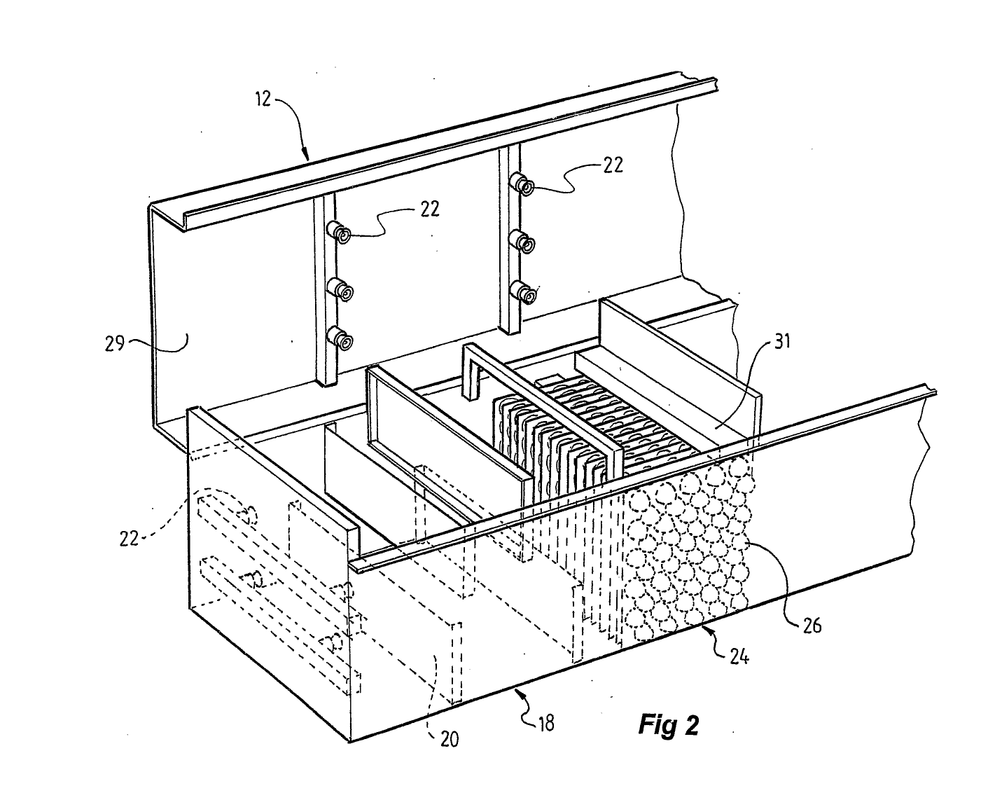

FIG. 2 is a perspective view of the air filter 12. A lid 29 of the air filter 12 has been opened to reveal the first space 18 and the second space 24. Jets 22 are disposed on the underside of lid 29 and when closed, the jets will be oriented above the second space baffles as described in FIG. 1 above. FIG. 2 also clearly shows the additional jets 22 in the first space 18 which are disposed to the side of first space baffles 20. The arrangement of first space baffles 20 in first space 18 can be seen. Furthermore the arrangement of second space baffles 26 can be clearly seen in space 24, the second space baffles being disposed within wooden box 31. In FIG. 2, the air inlet 14 (and corresponding fan 16) and air outlet 30 are not shown for clarity.

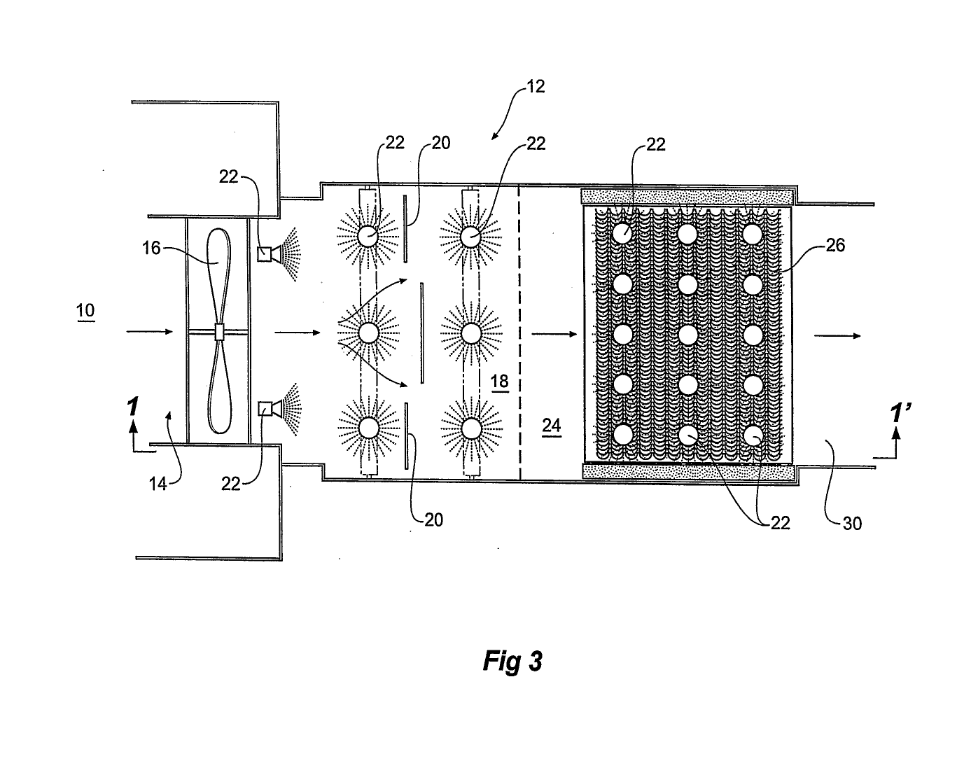

FIG. 3 is a cross-sectional top-view of the air filter showing the orientation of the components in FIGS. 1 and 2. The numbering is consistent with FIGS. 1 and 2.

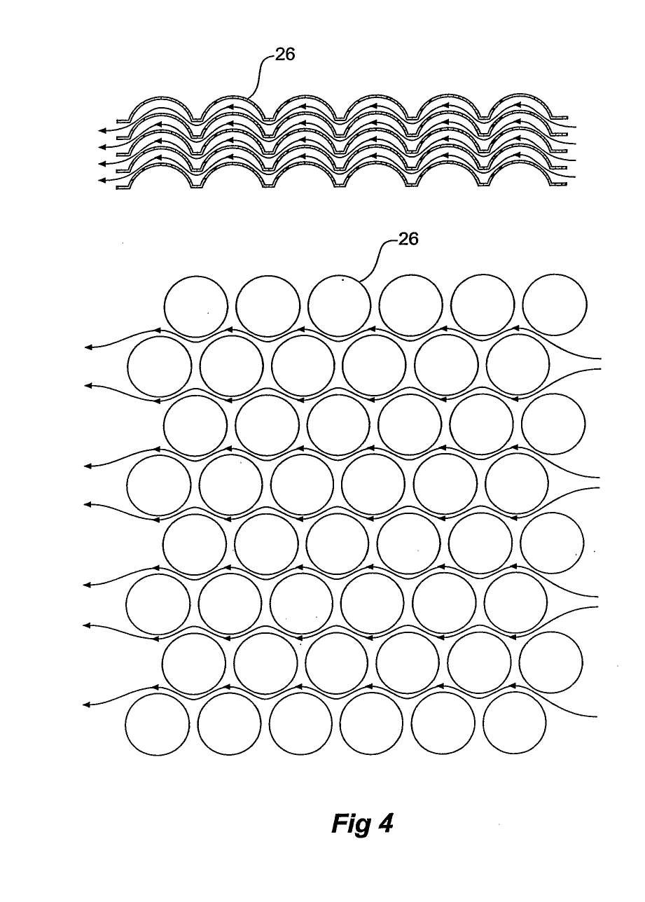

The shape of the second space baffles 26 is such that a continuous or semi-continuous vertical water stream flows over the surface of the second space baffles. The second space baffles 26 have structures which maximise the surface area which contacts the passing airstream. As can be seen in FIG. 4, the second space baffles are structured layers which have indentations and/or protrusions to increase surface area. In the preferred embodiment, the structured layers comprise curved protrusions which can be described as egg-carton shaped. The structured layers are stacked vertically so that the gaps between the individual layers form elongate vertically disposed channels in the approximate direction of the impinging airstream. The channels are open at the top to allow water to flow over the surface of second space baffles 26, and open at the bottom to allow water to drip off the bottom of second space baffles 26 and flow into a drain 28.

Once the air containing odour particles has been mixed in said first space 18 and passed through second space 24, over second space baffles 26, the amount of odour particles in the air is reduced. This air from which at least some particles have been removed is exhausted through air outlet 30. Effectively, the air exhausted from air outlet 30 has a lesser amount of odour particles than the air taken in via air inlet 14.

One possible way in which this invention works is described below. However, it should be understood that the invention is not limited to this explanation and other explanations may exist which better explain the workings of the invention.

All (or a substantial number of) the components of the first space 18 (as described above) are made from a material having a relatively low work function. The work function of a material is the amount of energy necessary to remove an electron from the surface of the material. By using a material with a relatively low work function in the first space, such as aluminium or steel, it is believed that a negative electric charge is imparted to the particles (odour particles or other type of particle such as pollen) entrained within the airstream. This negative charge is imparted by friction between the particles and the walls and baffles of the first space. This type of charging process is called triboelectrification.

The work function of a material can be ranked and listed in a Triboelectric Series. Below is a very short triboelectric series including the materials used in the present invention, i.e. steel and plastic. The materials included within this series are not exhaustive but are used for illustrative purposes only.

+ POSITIVE END OF SERIES (materials with lower work function)
asbestos
glass
nylon
lead
aluminium
steel
hard rubber
nickel & copper
brass & silver
synthetic rubber
plastic
teflon
silicone rubber

− NEGATIVE END OF SERIES (materials with higher work function)

Generally, a material that imparts a negative charge through friction will be one that is closer to the positive end of the series (e.g. steel). Note that the tendency of a material to become positive or negative after triboelectric charging has nothing to do with the level of conductivity (or ability to discharge) of the material. Materials with a low work function which are capable of imparting a negative charge to the particles are deemed to be within the scope of this invention. For example, all the components within the first space may be made from glass, lead etc.

In the second space 24, the second space baffles 26 are made from a plastic material with a higher work function than steel. Plastic is a dielectric material that is a poor conductor of electricity, but an efficient supporter of an electric field. The action of water droplets and streams of water flowing over the surface of second space baffles 26 very likely induces a passive electrostatic charge at the surface. The electrostatic charge increases the attraction between the surface of the plastic second space baffles 26 and particles in the airstream. The pre-treatment of the airstream in the first space 18 to form mixed air, increases the efficiency of particle removal since the first space 18 ensures that the particles, are more effectively attracted to the surface of second space baffles 26. This increase in efficiency is attributed to charging of the particles (including vapours) which increases the electrostatic attraction between the particles and the surface of second space baffles 26. Once the particles are entrained within the water flow (passing over the surface of second space baffles 26), the particles are effectively removed from the airstream, to produce an air containing fewer particles which is then exhausted from air outlet 30 of the air filter. In fact, the particles are effectively drawn out of the airstream passing over second space baffles 26 without having to effectively mix the water and airstreams. The exhausted air has a reduced amount of particles.

It will be understood that any material capable of supporting an electrostatic charge can be usefully employed in the second space 24 of the invention. For example, the second space baffles 26 can be made from porcelain (ceramic), mica, glass or the oxides of various metals.

It should also be understood that other methods of inducing a surface charge on second space baffles 26 could be used in the invention, for example contact electrification. However, by employing a water flow over the second space baffles, the surface is both charged and washed by the action of the water. Therefore, the second space baffles of the air filter do not require a cleaning step and can be continually used in the air filter without requiring disassembly.

It will be appreciated that the charge which is theoretically imparted to the particles in the first space 18 (as described above) may instead be a positive charge, rather than a negative charge. The positive charge may be imparted triboelectrically by a material with a high work function such as silicone rubber or Teflon. A positive charge imparted to the particles may also increase the electrostatic attraction of the particles to the second space baffles 26, which may however need to be formed from a different material which is more suited to electrostatically attracting particles pre-treated to have a positive charge.

Furthermore, said first space may not induce a charge on particles but may only serve to mix the air from the air intake with water (or air) released from the jets. If the first space does not induce a charge, particles may still be removed from the air due to inherent charges on the particles, however particle removal may be less efficient.

It is also an option that the air filter does not have a first space, the air containing particles simply being forced into the second space without pre-treatment. With reference to FIG. 1, if there is no first space, the air filter will consist of an air inlet 14 and an air outlet 30 having only baffles 26 disposed therebetween. Fluid releasing means (or jets) 22 will release a fluid over at least a portion of one or more baffles 26 which are oriented in substantially the same way as described in the embodiment above. As is the case above, the fluid can be either water or a substantially aqueous solution as desired.

In the case of an air filter having only one space, particle removal may be less efficient, however particles will still be removed from the air which contacts the one or more baffles nonetheless. This removal may be by the physical action of the water and/or, where the air contains charged particles, the charged particles may be attracted to the surface of baffles 26. As described in detail above, baffles 26 are preferably made from a material which supports an electrostatic charge (e.g. plastic) and the baffles 26 are charged by the action of water passing over the surface. It should be understood, that this space works in substantially the same way as the second space described above; there being a drain, and so forth, as is described for the second space above.

If desired, a space may be disposed following the second space in which air is baffled or agitated in order to remove a further portion of particles.

It is possible that the invention works in a different way from that described above and the invention is not limited with respect to the explanation provided.

It is an option that the spacing between second space baffles 26 is adjustable, depending upon the type of particle to be removed from the airstream and the amount of particles to be removed. Experiments have revealed that the spacing between second space baffles 26 plays an important role in particle removal. For example, a spacing of 1 mm may remove one type of particle, while a spacing of 2 mm may more efficiently remove another type. The spacing between second space baffles 26 is directly related to the surface area available for contact with the airstream. The overall size of the air filter has an effect on the spacing that is chosen. For example, the distance or spacing between second space baffles which have the dimensions 300 mm×300 mm is approximately 7 mm for maximum particle removal (see FIG. 2), but other spacings may prove to be useful in the invention. For example, if the second space baffles have the dimensions 1.5 m×2.3 m then the spacing may be 12.5 mm, etc. The spacing distance chosen between second space baffles 26 is pre-determined by experimental trial and error.

Experimental data also shows that the speed at which air is forced into or enters the air filter 12, as well as the flow rate of water over second space baffles 26, can be adjusted to increase the efficiency of particle removal. The air flow rate effects the contact time of the air with the surface of the second space baffles 26. Typical air flow rates are between 2 to 8 metres per second, although other air flow rates may prove to be beneficial in other embodiments of the invention. The water flow rate is controlled by the jets which in the preferred embodiment release water at 80 pounds of pressure per square inch (PSI). Again, the optimum air flow rates and water flow rates can be pre-determined by experimental trial and error.

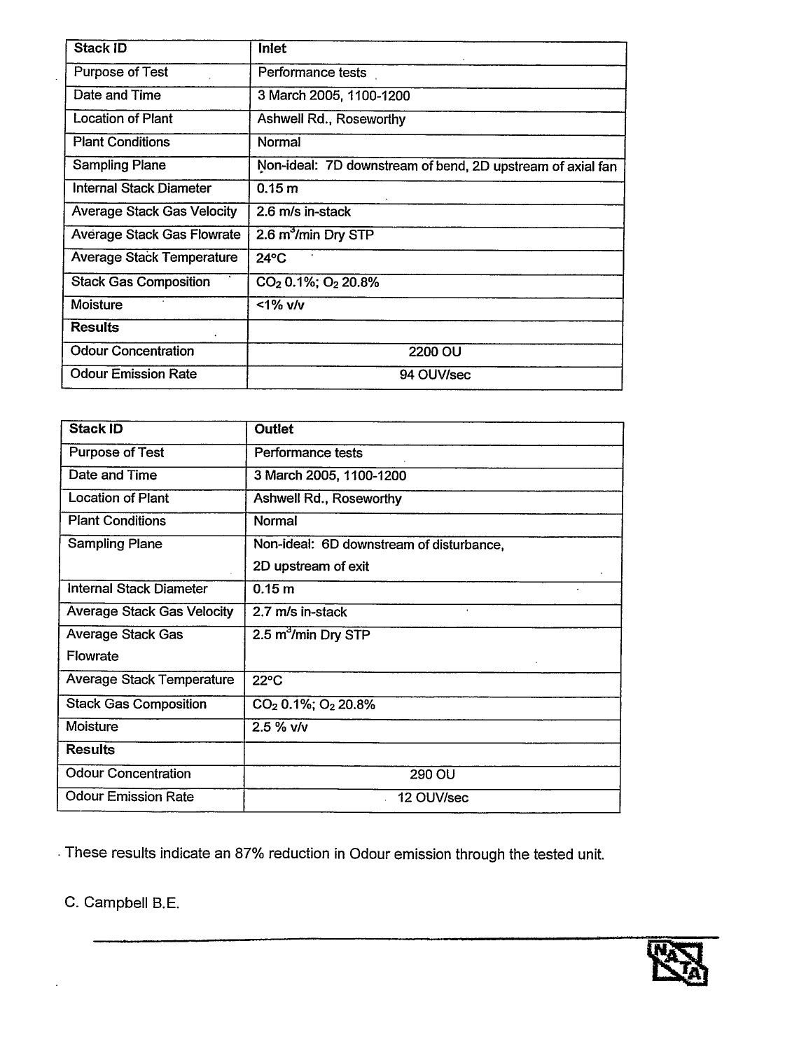

The air filtering capabilities of the air filter of the present invention were assessed by Enviroscan Industrial and Marine Surveys of Brighton, South Australia (NATA Accredited Laboratory). The results are shown in FIG. 5. The test procedures used are from the South Australian Environmental Protection Authority (EPA) Monitoring Manual, Volume 1: Air Quality “Emission Testing Methodology for Air Pollution” (1995). The odour sampling was conducted simultaneously at the air inlet 14 and air outlet 30 of the air filter.

By way of explanation, compounds require dynamic olfactometry for assessment of odour level. This involves exposing a selected and controlled panel of observers to precise variations in the concentrations of odour in controlled sequence, to determine the point at which only half the panel can detect the odour. The point at which only half the panel can detect the odour is called the “odour threshold” or one “odour unit”. The number of odour units is the concentration of a sample divided by the odour threshold.

In the present case, the air flow rate into the air filter was approximately 2.7 meters per second and the spacing between the second space baffles, (having the dimensions 300 mm×300 mm×1.2 mm) in the second space was 7 mm. The odour concentration measured at the air inlet (having a diameter of 0.15 m) was 2,200 Odour Units (OU) having an odour emission rate of 94 OU/second. At the outlet (having a diameter of 0.15 m), following treatment in the air filter of the present invention, the odour concentration was 290 OU, the odour emission rate being 12 OU/second. This corresponds to an 87% reduction in odour emission through the tested unit.

It is noted that for the above mentioned testing of air filter 12, the air inlet 14 and the air outlet 30 had the same diameter (0.15 m). In the preferred embodiment, however, the air outlet preferably has a larger diameter than the air inlet.

Although a preferred embodiment of the air filter of the present invention has been described in the foregoing detailed description, it will be understood that the invention is not limited to the embodiment disclosed, but is capable of numerous rearrangements, modifications and substitutions without departing from the scope of the invention. Modifications and variations such as would be apparent to a skilled addressee are deemed to be within the scope of the present invention.

For example, although the invention is generally discussed with reference to the removal of odour from poultry sheds, the techniques discussed can also be applied to the removal of other particles from other spaces such as apartment buildings, restaurants, or indeed from larger areas such as over odour-generating swamps or ponds.

The baffles used in the second area were plastic structured layers having an egg-carton type configuration. However, other materials may be usefully employed, for example, the baffles could be made from porcelain, and could have pyramidal shaped structures on the surface.

1. An air filter comprising
an air inlet to allow air containing particles to enter the air filter;
an air outlet to allow the air from which at least some particles have been removed to exit the air filter;
one or more baffles disposed between the air inlet and the air outlet to allow the air containing particles to contact at least a portion of the one or more baffles; and
one or more fluid releasing means for releasing fluid over the at least a portion of the one or more baffles, thereby in use inducing a charge on the surface of the baffles to which the particles are attracted, thereby reducing the amount of particles in the air which entered the air inlet.

2. An air filter according to claim 1, wherein the particles in the air are odour particles.

3. An air filter according to claim 1, wherein at least some of the particles in the air which contacts the at least a portion of the one or more baffles are charged.

4. An air filter according to claim 1, wherein the at least a portion of the baffles is made from a material capable of supporting an electrostatic charge.

5. An air filter according to claim 4, wherein the material capable of supporting an electrostatic charge is a plastic.

6. An air filter according to claim 1, wherein the fluid releasing means is a jets.

7. An air filter according to claim 1, wherein the fluid that is released by the fluid releasing means is water.

8. An air filter according to claim 1, wherein the fluid released by the fluid releasing means is an aqueous solution.

9. An air filter according to claim 1, wherein the one or more baffles have substantially vertical surfaces so that the fluid released from the fluid releasing means flows down the substantially vertical surfaces of the one or more baffles, the flow of the fluid thereby removing at least some of the odour particles attracted to the one or more baffles.

10. An air filter according to claim 1, wherein the fluid released drips from the bottom of the one or more baffles.

11. An air filter according to claim 1, wherein the air filter further comprises a drain for removing fluid released by the fluid releasing means.

12. An air filter according to claim 11, wherein the fluid from the drain is passed through a particulate and/or chemical filter and is then returned to the fluid releasing means for re-use.

13. An air filter according to claim 1, comprising at least two baffles which are spaced apart from one another.

14. An air filter according to claim 13, wherein the spacing between the at least two baffles is adjustable.

15. An air filter comprising:
a first space and a second space, disposed in air flow communication between an air inlet for receiving air containing particles and an air outlet for exhausting air from which at least some of the particles have been removed;
the first space including one or more first space fluid releasing means disposed to release first space fluid into the air containing particles flowing through the first space;
the second space including one or more second space baffles disposed to allow the air containing particles flowing through the second space from the first space to contact at least a portion of the one or more second space baffles, and further including one or more second space fluid releasing means for releasing second space fluid over the at least a portion of the one or more second space baffles thereby in use inducing a charge on the surface of the baffles to which the particles are attracted.

16. An air filter according to claim 15, wherein the particles are odour particles.

17. An air filter according to claim 15, wherein the first space further comprises one or more first space baffles, disposed so as to disrupt air flow through the first space.

18. An air filter according to claim 15, wherein a charge is imparted to the particles in the air flowing through the first space.

19. An air filter according to claim 15, wherein at least a portion of the first space is made from a material capable of inducing a charge on the odour particles.

20. An air filter according to claim 19 wherein the material capable of inducing a charge on the particles has a low work function.

21. An air filter according to claim 19, wherein the material capable of inducing a charge on the odour particles is steel.

22. An air filter according to claim 15, wherein at least a portion of the second space is made from a material capable of supporting an electrostatic charge.

23. An air filter according to claim 15, wherein the material capable of supporting an electrostatic charge is a plastic.

24. An air filter according to claim 15, wherein the first space fluid releasing means and the second space fluid releasing means is a jets.

25. An air filter according to claim 15, wherein the first space fluid or the second space fluid that is released by the first space fluid releasing means or the second space fluid releasing means respectively, is water.

26. An air filter according to claim 15, wherein the first space fluid and/or the second space fluid that is released by the first space fluid releasing means and/or the second space fluid releasing means respectively is an aqueous solution.

27. An air filter according to claim 15, wherein the first space fluid that is released by the first space fluid releasing means is air.

28. An air filter according to claim 15, wherein the one or more second space baffles have substantially vertical surfaces so that the second space fluid released from the second space fluid releasing means flows down the substantially vertical surfaces of the one or more second space baffles, the flow of the second space fluid thereby removing at least some of the odour particles attracted to the one or more second space baffles.

29. An air filter according to claim 15, wherein the second space fluid released in the second space drips from the bottom of the one or more second space baffles.

30. An air filter according to claim 15, wherein the first space further comprises a drain for removing first space fluid released by the first space fluid releasing means.

31. An air filter according to claim 15, wherein the second space further comprises a further drain for removing second space fluid released by the second space fluid releasing means.

32. An air filter according to claim 29, wherein the first space fluid and/or the second space fluid from the drain and/or the further drain respectively is passed through a particulate and/or chemical filter and is then returned to the first space fluid releasing means and/or second space fluid releasing means for re-use.

33. An air filter according to claim 15, wherein the second space comprises at least two second space baffles spaced apart from one another.

34. An air filter according to claim 33, wherein the spacing between the at least two second space baffles is adjustable.

35. A method of filtering air, the method comprising:
in a first space, mixing air containing particles with a first space fluid to produce mixed air;
causing the mixed air to flow into a second space, the second space having one or more second space baffles;
causing the air containing particles to contact at least a portion of the one or more second space baffles,
causing second space fluid to be released the one or more second space baffles thereby inducing a charge on the surface of the baffles;
in the second space, removing the particles from the mixed air by causing the air to be attracted to the charge induced on the surface of the baffles to produce air with a reduced amount of particles; and
expelling the air with the reduced amount of particles from the second space.

36. A method of filtering air according to claim 35, wherein the particles in the air are odour particles.

37. A method of filtering air according to claim 35, wherein the first space fluid is water.

38. A method of filtering air according to claim 35, wherein the first space fluid is an aqueous solution.

39. A method of filtering air according to claim 35, wherein the first space fluid is air.

40. A method of filtering air according to claim 35, wherein the method further comprises, in the first space causing the mixed air to pass over one or more first space baffles.

41. A method of filtering air according to claim 35, wherein the step of mixing in the first space facilitates inducing a charge on the particles.

42. A method of filtering air according to claim 41, wherein the step of inducing a charge on the particles includes causing the mixed air to flow over at least a portion of the first space which is capable of inducing a charge on the particles.

43. A method of filtering air according to claim 42, wherein the portion of the first space capable of inducing a charge on the particles has a low work function.

44. A method of filtering air according to claim 42, wherein the portion of the first space capable of inducing a charge on the particles is steel.

45. A method of filtering air according to claim 41, wherein the method further comprises, in the second space removing the charged particles.

46. A method of filtering air according to claim 45, wherein the step of removing the charged particles includes causing the mixed air to flow over at least a portion of the second space which is capable of removing the charged particles.

47. A method of filtering air according to claim 46, wherein the portion of the second space capable of removing the charged particles is made from a material capable of supporting an electrostatic charge.

48. A method of filtering air according to claim 47, wherein the material capable of supporting an electrostatic charge is a plastic.

49. A method of filtering air according to claim 35, wherein the second space fluid that is released by the second space fluid releasing means is water.

50. A method of filtering air according to claim 35, wherein the second space fluid released by the second space fluid releasing means is an aqueous solution.

51. A method of filtering air according to claim 35, wherein the one or more second space baffles have substantially vertical surfaces so that the second space fluid flows down the substantially vertical surfaces of the one or more second space baffles, the flow of the second space fluid thereby removing at least some of the particles.

52. A method of filtering air according to claim 35, wherein the method further comprises providing at least two second space baffles spaced apart from one another.

53. A method of filtering air according to claim 52, wherein the method further comprises adjusting the spacing between the at least two second space baffles.

54. A method of filtering air, the method comprising:
causing air containing particles to flow into a space via an air inlet;
causing the air containing particles to contact at least a portion of one of more baffles disposed within the space;
releasing fluid over at least a portion of the one or more baffles thereby inducing a charge on the surface of the baffles; and
expelling air with a reduced amount of particles from the space.

55. A method of filtering air according to claim 54, wherein the particles in the air are odour particles.

56. A method of filtering air according to claim 54, wherein the method comprises releasing water over a portion of the one or more baffles.

57. A method of filtering air according to claim 54, wherein the method comprises releasing an aqueous solution over a portion of the one or more baffles.

58. A method of filtering air according to claim 54, wherein the method comprises, causing air containing charged particles to flow into a space via an air inlet.

59. A method of filtering air according to claim 54, wherein the method comprises providing one or more baffles with substantially vertical surfaces so that the fluid flows down the substantially vertical surfaces of the one or more baffles, the flow of the fluid thereby removing at least some of the particles.

60. A method of filtering air according to claim 54, wherein the method further comprises inducing an electrostatic charge on the one or more baffles by causing the fluid to flow over the surface of the one or more baffles.

61. A method of filtering air according to claim 54, wherein the method further comprises providing at least two second space baffles spaced apart from one another.

62. A method of filtering air according to claim 61, wherein the method further comprises adjusting the spacing between the at least two second space baffles.

63. An air filter, according to claim 1, further comprising a space disposed between the air inlet and the one or more baffles.

64. An air filter according to claim 63, wherein a charge is imparted to the particles in the air flowing through the space.

65. An air filter according to claim 64, wherein at least a portion of the space is made from a material capable of inducing a charge on the particles flowing through the space.

66. An air filter according to claim 65 wherein the material capable of inducing a charge on the particles has a low work function.

67. An air filter according to claim 65, wherein the material capable of inducing a charge on the odour particles is steel.

68. An air filter according to claim 63, wherein the space comprises at least one fluid releasing means for releasing fluid into the air flowing through the space.

69. An air filter according to claim 68, wherein the fluid that is released by the fluid releasing means is water.

70. An air filter according to claim 68, wherein the fluid released by the fluid releasing means is an aqueous solution.

71. An air filter according to claim 68, wherein the fluid released by the fluid releasing means is air.

72. An air filter according to claim 63, wherein the space further comprises one or more first space baffles, disposed so as to disrupt air flow through the space.
